(19) United States
(12) Patent Application Publication
(10) Pub. No.: US 2018/0101776 A1
(43) Pub. Date: Apr. 12, 2018

(54) Extracting An Emotional State From Device Data

(71) Applicant: Microsoft Technology Licensing, LLC, Redmond, WA (US)

(72) Inventors: Neal Osotio, Sammamish, WA (US); Eva Marina Illescas Sanchez, Bellevue, WA (US); YoungSun Park, Bellevue, WA (US); Llewyn Elise Paine, Bellevue, WA (US)

(21) Appl. No.: 15/291,305

(22) Filed: Oct. 12, 2016

(51) Int. Cl. G06N 5/04; G06F 17/30; G06N 99/00; G06N 3/00

(52) U.S. Cl. CPC G06N 5/04; G06N 3/006; G06N 99/005; G06F 17/30569

(57) ABSTRACT

Representative embodiments disclose mechanisms to extract an emotional state from contextual user data and public use data collected from one or more devices and/or services. The contextual and public data are combined into an enriched data set. An emotional model, tailored to the user, extracts an emotional state form the enriched data set based on one or more machine learning techniques. The emotional state is used to identify one or more actions that change operation of one or more devices and/or services in order to achieve a change in emotional state, compatibility between the emotional state and device and/or service interaction with the user, or both. Implicit and/or explicit feedback is collected and used to change prediction of the emotional state and/or selection of the actions.

### FIELD

This application relates generally to human and machine interaction. More specifically, embodiments disclosed herein collect data from user devices, environmental sensors, online sources, and other locations and extract an emotional state from the variety of data and use the emotional state to customize the interaction of systems with a given user.

### BACKGROUND

Humans interact with a wide variety of machines in ever increasing numbers. Digital assistants have been crafted to provide timely information to users and to assist in a wide variety of tasks. Mobile and other devices are crafted with user interfaces that encompass not only text and graphics but also voice recognition. Chat bots have taken the place of humans in providing assistance and interaction in some instances. Artificial intelligence has been incorporated into various machines to make them more capable and useful. All these efforts have been to improve the ease of interaction with machines and to make them more useful to individuals. However, although services and systems collect an ever-increasing amount of data in the name of personalization and customization, machines are in many instances still difficult to use and are not customized well to a user in order to make them more acceptable to a user.

It is within this context that the present embodiments arise.

### BRIEF DESCRIPTION OF DRAWINGS

FIG. 1 illustrates an example architecture of a system to extract an emotional state from various data sources.

FIG. 2 illustrates an example learning loop to improve a system's ability to extract an emotional state from collected data.

FIG. 3 illustrates an example flow diagram to extract an emotional state from data and to customize operation of a system based on the extracted emotional state.

FIG. 4 illustrates an example architecture to identify an emotional state from data and to customize operation of a system based on the extracted emotional state.

FIG. 5 illustrates another example architecture to identify an emotional state from data and to customize operation of a system based on the extracted emotional state.

FIG. 6 illustrates another example architecture to identify an emotional state from data and to customize operation of a system based on the extracted emotional state.

FIG. 7 illustrates a representative machine architecture suitable for implementing the systems and so forth or for executing the methods disclosed herein.

### DETAILED DESCRIPTION

The description that follows includes illustrative systems, methods, user interfaces, techniques, instruction sequences, and computing machine program products that exemplify illustrative embodiments. In the following description, for purposes of explanation, numerous specific details are set forth in order to provide an understanding of various embodiments of the inventive subject matter. It will be evident, however, to those skilled in the art that embodiments of the inventive subject matter may be practiced without these specific details. In general, well-known instruction instances, protocols, structures, and techniques have not been shown in detail.

### Overview

While efforts have been made to increase user satisfaction through personalization of device and/or service operation, these efforts ignore changes in how users interact with devices and/or services that occur with changes in the user's emotional state. Thus, personalization of device/service operation has fallen short in many ways.

Extracting an emotional state from data is a difficult technical problem. Equally difficult is changing the operation of devices/services in response to an extracted emotional state and predicting the impact of changed operation on the user. In other words, it is difficult to detect the emotional state of a user and no devices/services are able to take advantage of the emotional state of a user even if known.

Embodiments disclosed herein extract the emotional state of a user from collected data. Other embodiments disclosed herein are devices/services that customize the interaction of the device/service based on the extracted emotional state. Such customization can include changing interactions of the device with the user and/or initiating actions designed to change the extracted emotional state.

Devices collect a wide variety of data with the permission of the user, many of which contain cues as to the emotional state of the user. For example, biometrics are often related to emotional state and include such data as heart rate, skin temperature, respiration, and so forth, which can be collected by wearables such as a watch, fitness tracker, band or other such device. Communications, through text, email, voice, and other mechanisms contain emotional clues in the language used, the timing of communications, the length of the communications, the length and structure of sentences and so forth. Visual clues to emotional state are contained in body language, eye contact, and so forth. Even how a user interacts with a device, such as the force of typing on a keyboard, the smoothness and pressure of an ink trail, the pressure and duration of a tap on a touch input device, and so forth contain clues to emotional state.

However, even common data (i.e., data with the same “value” from different users) can indicate different emotional states in different individual users. For example, one user may naturally strike a keyboard with more finger force than another, so a measurement in one user that may tend to indicate frustration may not be indicative of the same emotion in another user. Thus, embodiments disclosed herein utilize a personally tailored emotional state model to extract an emotional state from collected data. The emotional state model is derived using any number of machine learning techniques. The initial model can be established by using collected data to train the initial model. Thereafter, interaction with the user and feedback from the user is used to refine the model and to keep it current over time, to account for changes in a user's reactions and desires.

Once an emotional state has been extracted from data, the emotional state is used to select at least one action to be performed. This selection can be made by a more centralized system or server or can be made by a local device. The actions selected tend to have the goal of modifying the operation of one or more systems to make the way the system interacts with a user more compatible with the user's emotional state, changing the emotional state of the user, or both. The selected action(s) can be performed by the device/service that collected the data or other devices/services not necessarily associated with collected data. For example, an elevated heartrate can be detected by a wearable device and that information, when combined with the content of an email the user is reading on one device may lead to the inference that the user is upset. In response, the system can change the temperature of the room where the user is located, gradually change the music and adjust the interaction of the device to remove extraneous distractions (low priority notifications, rearranging the user interface, etc.) for a period of time to allow the user some time to deal with the emotion. In this example, both systems involved in data collection (i.e., the device) and systems not involved in data collection (i.e., music player and temperature control) are adjusted based on the extracted emotional state. Action selection can be based on a model personalized to the user which has been created, for example, by a machine learning process, based on rules/policies, combinations thereof, or another process.

Feedback, explicit and/or implicit, is used to refine the emotional state model and/or the selected action(s) in order to refine the system's ability to predict and/or appropriately respond to the extracted emotional state.

### DESCRIPTION

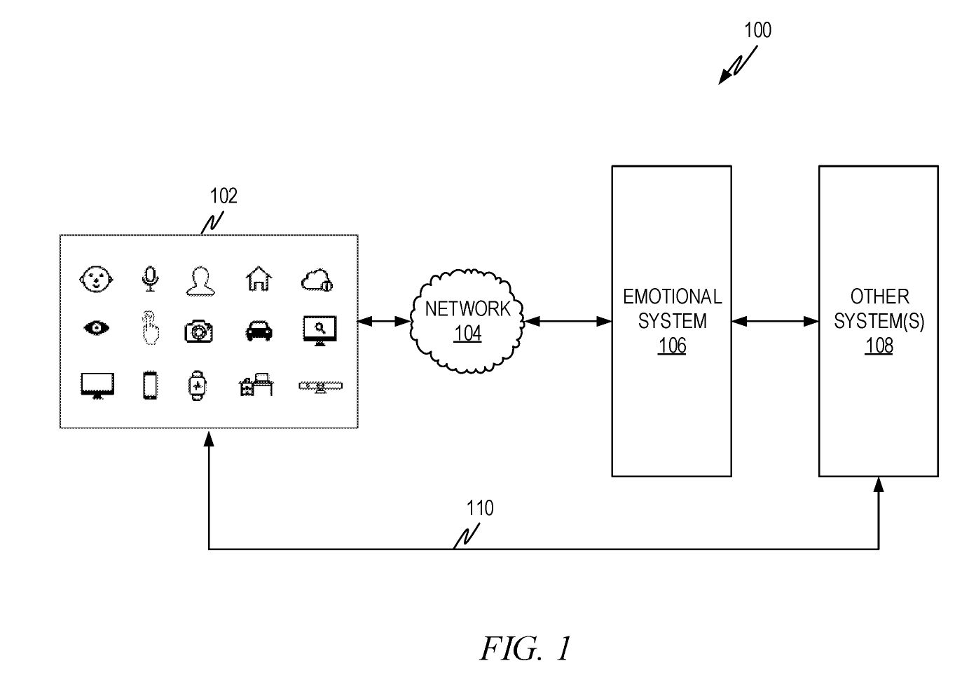

FIG. 1 illustrates an example architecture 100 of a system to extract an emotional state from various data sources. With the permission of a user, a wide variety of data is collected about a user by various devices and/or services 102. For example, search engines and online retailers keep track of users' searching and browsing history. Devices collect location information, biometric (heart rate, skin temperature, respiration, etc.), movement history, application utilization, and/or a wide variety of other data. Services and applications can analyze communications, such as text, email, voice, and other mechanisms to extract information about a user, the individual whom the user is communicating with, the tone of communication, the word choice, sentence length, the substance of the user's communications, and so forth. Cameras can capture body language, eye contact, eye tracking, eye coordination, facial recognition, and so forth. Sensors can capture information about a user's environment (temperature, lighting, music playing, ambient noise level, and/or so forth), the force of typing on a keyboard, the smoothness and pressure of an ink trail, the pressure and duration of a tap on a touch input device, and/or so forth. Biometric data is or can be collected by a wide variety of devices and sensors and includes data related to physiological characteristics (i.e., fingerprint, facial features, heart rate, blood pressure, and so forth) and behavioral characteristics (how a person moves, is acting, gestures, and so forth).

The services, data sources, and/or devices 102 represented in FIG. 1 represent the wide variety of devices, systems and/or services that collect information about a user and that can be sources of data for extracting an emotional state. Additionally, data sources are also represented. By way of example, and not limitation, such devices and services can include mobile devices such as watches, bands, fitness trackers, mobile phones, and so forth, semi-mobile devices such as laptops, tablets, and so forth, desktop systems, server systems, “smart” devices that are part of the so called “Internet of Things” (furniture with sensor data to collect posture data, smart toilets that monitor health, refrigerators that monitor diet patterns, customized water temperature, lighting and lighting control devices such as electric light sources and/or ambient light sources, ambient audio and noise generators, and so forth), cloud services as well as devices that may not be within the conventional definition of a device, but which still have and collect data about a user such as a vehicle. Data collected from the service(s) and/or device(s) 102 are sent over a network 104 to an emotional system 106.

The network 104 can be any combination single network, multiple networks, private networks, public networks and so forth. Additionally, as explained below, emotional system 106 can be monitoring data from multiple users, user devices, etc. which can be connected through different networks. For example, an individual user may be connected through a private network, over which personal information is conveyed. In another example, multiple users may be connected together over a private network, such as an internal corporate network. In a further example, multiple users may be connected over a public network, such as a public teleconference. Combinations are also possible. For example, a user may be connected to other users over a public network from which the emotional system 106 collects information on the user and the other users. Separately, the user may also be connected to the emotional system 106 over a private network over which personal information is relayed.

The emotional system 106 selects an appropriate set of data and creates an enriched set of data from which an emotional state can be extracted. The enriched set of data typically comprises data from multiple sources. In creating the enriched set of data, the system can perform various data processing options to ensure the data is consistent. Such data processing options can include one or more of: reducing the number of data points from one or more of the plurality of data sources (removing extraneous data, removing data that is obviously wrong, reducing the overall number of data points, etc.); aggregating data points from the plurality of data sources (combining multiple sets of data into a single set of data, etc.); time aligning data points from the plurality of data sources (matching data point time scales, time shifting, etc.); normalizing the data from one or more of the plurality of data sources; changing format of the data from one or more of the plurality of data sources; creating feature vectors from the data; and/or other data processing techniques that allow data from multiple different data sources to be combined.

The emotional state is extracted from the enriched data through a personalized emotional state model, created through one or more supervised or unsupervised machine learning processes, such as a support vector machine (SVM) technique, a convolutional neural network, a deep neural network, decision tree process, k nearest neighbor process, kernel density estimation, K-means clustering, expectation maximization, and so forth. The enriched data is presented to the emotional state model for the user and an emotional state is extracted from the data. The emotional state may be combined with other data, in some instances, such as an indication of user intent, an indication of what the user is doing, and so forth, to create a set of personalized emotional state data that can be acted upon by the emotional system 106, other systems/services 102, 108 or both. The combination of emotional state and other information, if any, will be referred to as the emotional state vector, although the specific data format and storage mechanism can vary from embodiment to embodiment. Thus the emotional state vector can comprise the emotional state and/or the emotional state and other information.

The emotional system can pass the emotional state vector to other systems/services to allow the system to utilize the extracted emotional state, can use the emotional state vector to identify one or more actions to be taken based on the emotional state vector, or any combination thereof. In the first type of embodiment (the emotional system 106 passes the emotional state vector to other systems/services), systems or services can register for notification upon certain conditions. For example, some systems/services may register to have the emotional state vector passed anytime it is updated. Other systems/services may register to have the emotional state vector passed based on a policy or other criteria. In the latter case, the policy can specify any combination of criteria such as being notified of only certain emotional states (or other information in the vector), being notified only when an event or combination of events occur, being notified when an event or combination of events does not occur, being notified based on time, or any other criteria, set criteria or combinations thereof.

The emotional system 106 evaluates the policy for notification and, when evaluation of the criteria indicates the notification should be sent, the emotional system 106 formats the emotional state vector and sends it to the subscribed system/service. Thus, the emotional system 106 can send the emotional state vector back to a system/service that was a source of data like services/devices 102 or can send the emotional state vector to a system/service that was not a source of data such as the other system(s) 108.

Data path 110 represents communications between the user/user devices 102 and the other system(s) 108. For example, in a conference call scenario presented below, the emotional system 106 monitors the conversations and interactions among a group of individuals, connected together in different ways. The emotional system 106 detects the various emotional states of the users and feeds that into a digital assistant that may or may not be part of the initial conversation. The assistant can then step into the conversation as appropriate. Thus, the emotional system can actually be a trigger to call other systems into interaction with a user. As another example scenario, the emotional system is monitoring a mobile phone conversation along with a digital assistant that is also monitoring the conversation. When the emotional system detects an increase in anger, it can pass that emotional state to the digital assistant. In response, the digital assistant may interact with the user in a manner designed to calm the user. For example, the user may provide haptic feedback directly to the user's wearable device. Data path 110 allows the digital assistant to interact directly with the wearable without going through the emotional system. Data path 110 also represents the information coming from the user/user devices (arrow is bidirectional), so the emotional system and a digital assistant, etc. could both be monitoring and utilizing information from devices, user, and so forth as explained below.

In embodiments where the emotional system 106 identifies one or more actions to take in order to influence the emotional state, change the way a system operates or both, the emotional state vector can be associated with one or more “emotional modules” in the system. These emotional modules are designed to initiate one or more actions in either a proactive or reactive manner.

In addition to providing “immediate” emotional state vectors that represent the current emotional state of a user, the emotional system 106 can store past emotional state vectors for use by systems in creating proactive actions, as illustrated in greater detail below.

The following example scenarios illustrate various actions that can be taken and the notion of proactive and reactive operation.

The first scenario is a productivity scenario and illustrates proactive and reactive responses to emotional insights (i.e., emotional state vector) captured from user conversations and interactions. In this scenario, James, a Product Marketing Manager is working to complete a slide presentation that he is scheduled to deliver to leadership later in the week. Since most of his team is working in multiple locations, they are using a conference/collaboration system to collaborate on finalizing the presentation content together. In addition to the conference/collaboration system, a digital assistant system is also “listening” in to give suggestions to the group. James and two colleagues Linda and Steve are calling in from a conference room in their building. Kim is calling in from her home office as is Rashid while Max, currently on vacation with his family is dialed in on his mobile phone. As with previous leadership presentations, the short deadline is creating pressure.

The emotional system 106 monitors the interaction between the team member through evaluation of the content of conversations extracted from the conversations via conference/collaboration system and from the conversations among the users in the conference room. This involves an analysis of the audio conversation as well as any text “chats” among the participants, either through the conference/collaboration system or through another channel. Voice conversations can be captured and a speech to text algorithm utilized to extract the text of the conversation as well as identify the individual speakers. Additionally, or alternatively, an algorithm can be used to capture tone of voice, volume, and other indicators of a user's emotional state. Finally, each user may have one or more individual devices such as wearable or phone that gathers and provides information used to identify the emotional vector for each member of the team.

The conference call starts off smooth and the team initially agrees on the content and points they want to highlight in the presentation deck. The emotional system detects the emotional state of the various participants and creates the emotional vectors for each individual. The emotional vectors are associated with a plurality of processes (i.e., emotional modules) so that recommended actions can be taken based on the emotional content.

At one point in the collaboration process, the digital assistant enters the conversation and recommends supporting visual images to add to the presentation for greater storytelling impact. This is an example of a proactive action taken on behalf of the digital assistant. The proactive action can be based on a proactive emotional insight. For example, the emotional system 106 supplies emotional responses of the leadership audience to past presentations along with the context for the emotional responses (e.g., the content of the presentations that created the emotional response). The digital assistant can evaluate the emotional response, the content that created the emotional response, and based on commonality between the leadership audience, similarity between the presented content and a positive emotional response, select suggested visual images to be included in the presentation.

As the team moves into more difficult parts of the presentation, the tone of the conversation and the team collaboration dynamic becomes more serious and tense. Max in particular is getting very frustrated with the progress. The process stalls. The emotional system 106 identifies the frustration and the various emotional states of the team by evaluating the data captured from the team's individual devices, tone of voices, and the content of their communications. The emotional state vector for each individual is used to identify an action calculated to change the emotional state vector for Max, who is very frustrated. The action is reactive in that it is reacting to the emotional state vectors.

Actions can be identified by providing the emotional state vectors for the team to one or more emotional processes that identify actions to be taken based on a particular emotional state vector. The emotional processes can represent models created through one or more supervised or unsupervised machine learning processes, such as a support vector machine (SVM) technique, a convolutional neural network, a deep neural network, decision tree process, k nearest neighbor process, kernel density estimation, K-means clustering, expectation maximization, and so forth.

In the present scenario, the processes identify an action to have the digital assistant recommend that Max and James work individually together on that part of the presentation. This can be identified, for example, by evaluating Max's emotional state vector which indicates a negative emotion such as frustration, a context which is collaborating on a presentation, with progress stalled on discussions for a particular section. Historical insight captured by the emotional process (model) may indicate that Max often feels frustration when progress is not being made. The process can then make the inference that restoring progress may lower Max's frustration (move his emotional state in a positive direction). Thus, the process would calculate that skipping over the section or having a subset of the users work on it would be a recommendation that would be most likely to lower frustration and restore progress.

If the recommendation is accepted, two points of feedback are realized by the system. First, acceptance of the recommendation is explicit feedback that the recommendation useful and a point of reinforcement for the action selection process result. Second, because progress is restored, Max settles down and the change in the emotional vector of Max is identified. This provides indirect feedback to both the emotional model for Max and for the action selection process to accommodate the insight that in a group dynamic, Max's frustration level may be lowered by increasing the forward progress on a project.

The rest of the team continues to collaborate together to finish out other portions of the deck. The digital assistant continues to consult with and guide the team through both proactive and reactive guidance. Later, the whole team joins back together and combines their parts into the final presentation.

The second scenario illustrates that data collected from one source can be used to trigger an action on another device/service.

Bill and Kathy are getting ready to go to work. Bill works full-time at a software development company and Kathy works part-time as a substitute teacher for the local school district. On the days that they are both working, their son Jeromy, who has autism, attends a special needs center. This particular morning while getting Jeromy ready to go they noticed that he was a bit agitated and difficult, more than his usual self. They sensed that today could be a difficult day for Jeromy.

The first half of Jeromy's morning goes well and he is cooperating with his care givers and peers at the center. But as the day goes on, he is becoming more and more agitated and frustrated with the activities around him. The kids at his center have been extremely boisterous, which interrupted Jeromy's regular routine. The result being a strong emotional reaction from him triggering an episode.

Jeromy's smart watch sends data including hear rate and arm movement to the emotional system 106. Sensors in the environment measure ambient noise level and also send that data to the emotional system 106. The emotional system 106 combines the data into an enriched data set and presents the information to an emotional state model for Jeromy. The resultant emotional state vector indicates that Jeromy is undergoing a negative episode and includes context data regarding the ambient sound level.

The emotional system 106 presents the emotional state vector for Jeromy to one or more emotional processes to identify one or more actions to be taken. The emotional processes have “learned” from the past that providing haptic feedback to his watch (soothing emotionally calming vibrations in a pattern familiar to Jeromy) helps adjust the emotional state in a positive direction. Additional actions that are identified to help are lowering the ambient noise, familiar sounds and/or visual images. Thus, another identified action is to send an alert to Jeromy's care givers that improvement can be made through these measures. In this situation, the notification channel and intended device may be different from any device or sensor used to collect information.

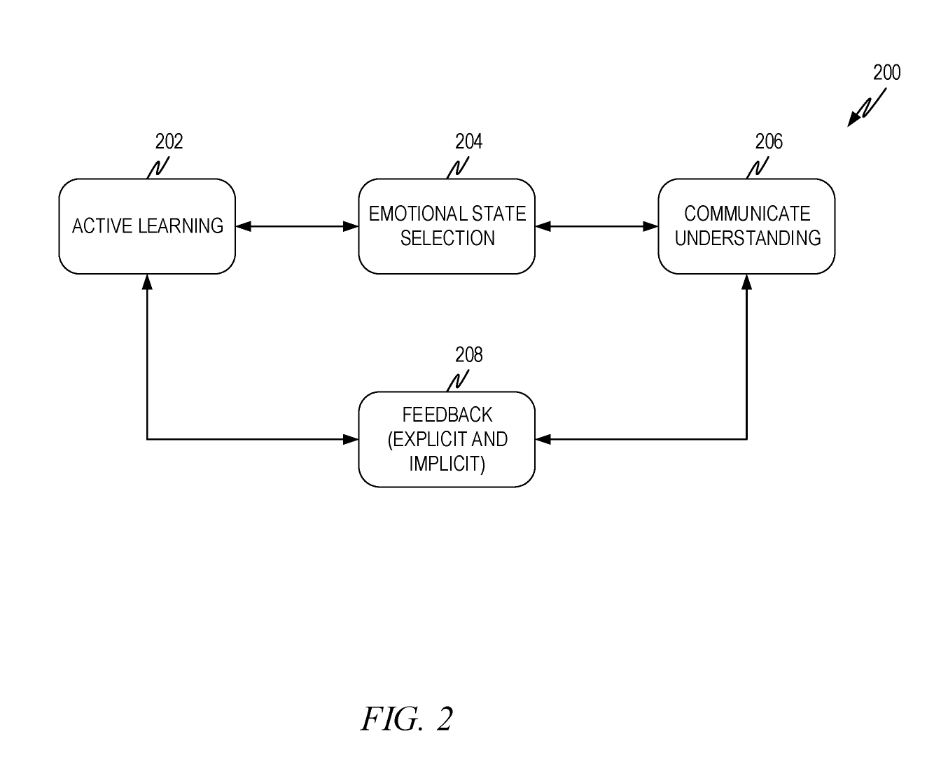

FIG. 2 illustrates an example learning loop 200 to improve a system's ability to extract an emotional state from collected data. As discussed above, the systems use an emotional state model personalized to each user. This personalization is an active learning process 202 that ensures that the model is both personalized to a particular user but also adapts to changes in how the user reacts to situations.

The emotional state model is created through one or more supervised or unsupervised machine learning processes, such as a support vector machine (SVM) technique, a convolutional neural network, a deep neural network, decision tree process, k nearest neighbor process, kernel density estimation, K-means clustering, expectation maximization, and so forth. These individual machine learning processes each have particular training requirements (supervised or unsupervised). Initial training can be accomplished either by starting with a “standard” model that adapts over time to be personalized to the user or by using a batch of collected data for initial training.

Once the model is created, collected data is presented to the emotional state model (operation 204) in order to extract an emotional state as discussed above. The emotional state may be combined with other data (contextual data, etc.) to create an emotional state vector. This emotional state vector represents the emotional inferences extracted from the data.

Operation 206 illustrates that the emotional system communicates its understanding to the appropriate devices/services. Communicating understanding may be communicating the emotional state vector or may be using the emotional state vector to identify one or more actions to be initiated based on the emotional state vector.

As seen in the examples above, implicit or explicit feedback indicates to the system the accuracy of the extracted emotional state and the appropriateness of the selected actions. When actions comprise presenting recommendations, accepting the recommendation is explicit feedback that the recommendation was appropriate. Additionally, monitoring changes in the extracted emotional state can provide a source of implicit feedback that the selected action was appropriate. Directly monitoring other data also provides either explicit or implicit feedback. Thus, a user's communications, actions, and so forth may provide direct information about whether the extracted emotional state and/or selected action(s) were appropriate. In this context appropriate means that they either achieve or helped achieve the intended effect.

Operation 208 represents the feedback obtained as described above. The feedback drives the active learning processes as indicated above.

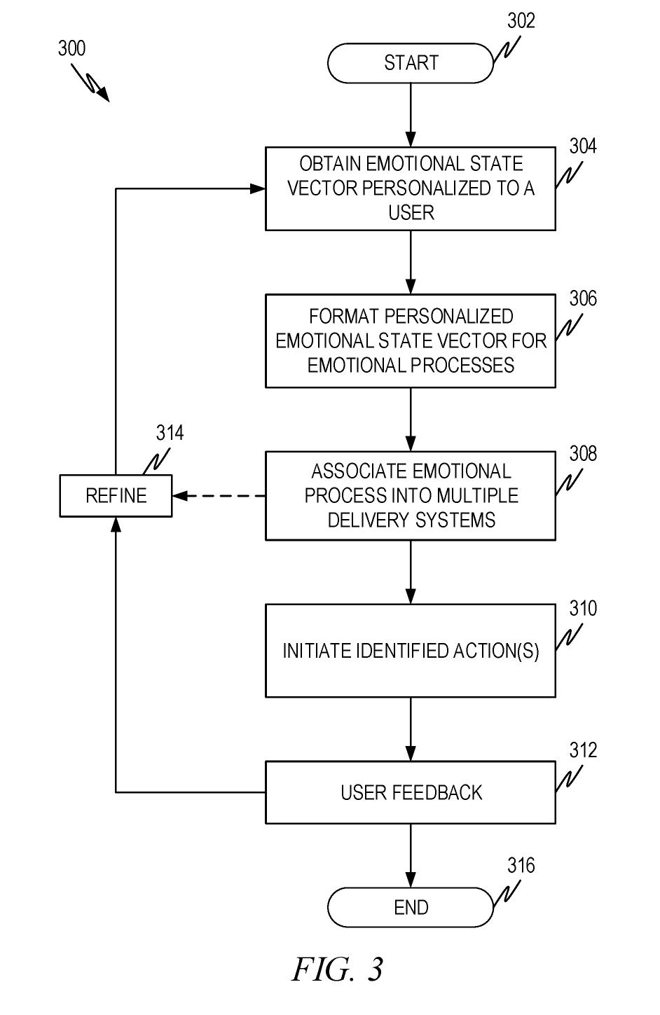

FIG. 3 illustrates an example flow diagram 300 to extract an emotional state from data and to customize operation of a system based on the extracted emotional state. The method begins with operation 302 and proceeds to operation 304 where personalized emotional content (i.e., the emotional state vector for a given user) is obtained from a emotional state model for the user as explained above.

Operation 306 formats the emotional state vector for emotional process(es) used to identify actions to be taken based on the emotional state vector. These emotional processes can be associated with different types and/or groups of actions and provide the reactive mode of operation for the emotional system. In other words, these emotional processes are the processes that watch the emotional state and identify actions that are intended to change the operation of a system to make the system more compatible with or make the devices/services interactions more compatible with the user's emotional state, intended to change the extracted emotional state, or both. In many instances, changing a device/service to make it more compatible with the user's emotional state will have an effect on the extracted emotional state.

Actions intended to change one or more devices/services to make them more compatible with the identified emotional state vector can fall into three, non-exclusive categories: 1) changing operation of devices/services that impact the user's environment; 2) changing operation of devices/services that impact the user's digital environment; and/or 3) changing interaction of a device/services with the user. These three categories apply to all embodiments described herein. Devices include overall systems and so forth as previously explained.

Changing operation of devices/services that impact the user's environment include such items as changing lighting, temperature, humidity, ambient noise, audio background (i.e., start/stop/change music, music genre, increase/decrease white noise generator level, etc.), and so forth. A user's environment is where ever the user is, such as home, office, vehicle, outside, and so forth. These changes can come in the form of control, either directly or through one or more other systems, or in the form of recommendations that a user can use to modify their own environment. Of course, the amount of control that the emotional system can exert, either directly or through other systems, changes dramatically depending on a user's environment. However, recommendations can help the user change their own environment. Thus, when the system cannot adjust the lighting, like when a user is outside, the system can recommend that the user move to a place where the lighting would be in line with the adjustments the system would make.

Changing operation of devices/services that impact the user's digital environment include changing user interfaces to increase or decrease user interface elements and/or notifications, changing text size, changing text color, screen color, background pictures, limit or grant access to certain applications, programs and/or services, adjusting screen brightness and/or tone, and so forth. These changes can also come in the form of control, either directly or through one or more other systems, or in the form of recommendations that a user can use to modify their own environment. Thus, if a user tends to want to be left alone when angry, the system can silence the ringer on a mobile device, turn off text notifications either completely or from a certain list of people, eliminate chat notifications, and so forth. Additionally, or alternatively, for programs, applications and so forth that have multiple modes of communicating, the mode of communicating can be changed and/or the circumstances under which communication is made can be changed.

Changing interaction of a device/services with the user include changing voice, text or other communicative interactions with the user. This covers a wide variety of systems and modes of interaction. Changing interactions can adjust frequency of interactions, tone of communications, word choice in communications, length of sentences/notifications used in interactions, speed of communication (i.e., how fast does the system answer, etc.), and so forth. Digital assistants, for example, interact with users through voice, text, and other mechanisms. They also have “triggers” which indicate under what circumstances and how often they are activated. Changing interaction for digital assistants can change parameters not only for communication channels (voice, text, etc.) but also under what circumstances and how often they trigger. For example, based on past experience, the learning models may adjust the emotional state model and/or emotional processes to know that when a particular user is frustrated, they prefer little or no interaction. Thus the frequency of interaction (under what circumstances and how often a digital assistant is triggered) can be lowered. For communications that do occur, the model and processes may understand that text, rather than voice is the preferred communication channel in those circumstances and that the text should be kept short. For another individual frustration may call for more frequent interaction, voice and longer conversations. Thus, the experiences are customized for the user.

Adjusting the frequency of interaction can be accomplished by ranking and/or classifying the events and/or circumstances (collectively events) that trigger interaction. Classification can be performed, for example, by identifying the type of interaction and/or the type of event/circumstance that causes the trigger. For example, events that indicate a trigger based on providing some sort of help can be classified into one classification, events that indicate an upcoming appointment or phone call (i.e., something the user has to do) can be classified into another classification, and so forth. Additionally, or alternatively, classification can be based on the type of communication and the mechanism by which communication is accomplished. For example, popup notifications in one category, voice notifications in another category and so forth. Ranking can be performed based on either explicit user input such as by a user adjusting settings or preferences, or implicit criteria, such as relying on the learning models previously discussed to identify the relative importance of various interactions to the user.

Once the events and circumstances are ranked and/or classified, the identified action(s) can adjust the frequency by removing triggers for categories of events and/or lower ranked events based on the emotional state vector.

Operation 308 associates the output of the emotional process(es) into multiple sensory delivery systems. In other words, once the action(s) are identified, a channel is selected to deliver the action to the user. In this sense, a channel can comprise both a communication channel (wireless network, wired network, a given protocol, technology, etc.) and one or more target devices. Thus, in the above example of Jeromy, the system identified two actions: 1) notify care givers that adjusting the ambient noise would help and 2) providing haptic feedback to Jeromy's watch. The identified actions can be mapped to one or more communication channels. Thus, the notification action could be mapped to the care giver's desktop devices and mobile devices and be delivered over a wired/wireless network the target devices are connected to and the haptic feedback action could be mapped to Jeromy's watch.

An optional output of operation 308 is to loop back to the processes that refine (operation 314) the emotional state vector and/or the emotional process(es) that select identified actions derived from the emotional state vector. To the extent that there is information to feedback at this point, the information can be used. For example, operation 308 may identify that a device is unavailable and the process should select a different action.

Operation 310 initiates the identified actions through the selected channel. Thus, information can be presented to the user, to others, or any other actions initiated.

Operation 312 receives explicit and/or implicit feedback as previously discussed and sends it back into the system (operation 314) to refine the emotional state vector and/or emotional processes.

The diagram ends at operation 316, although in practice this is a continuous refinement loop and the process really doesn't end.

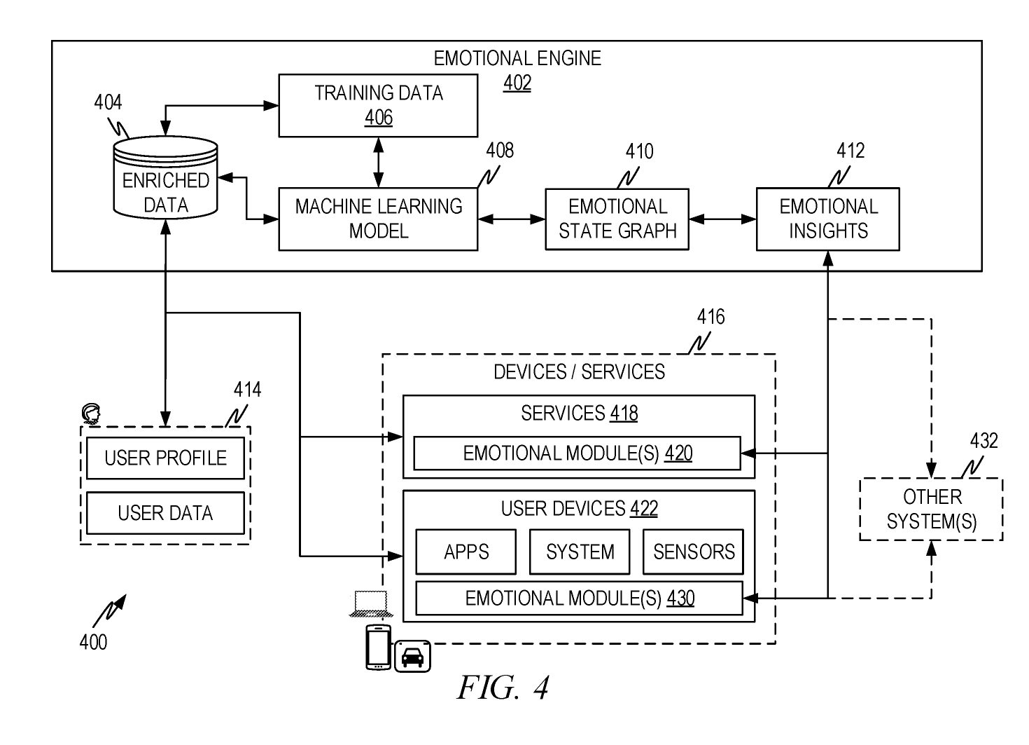

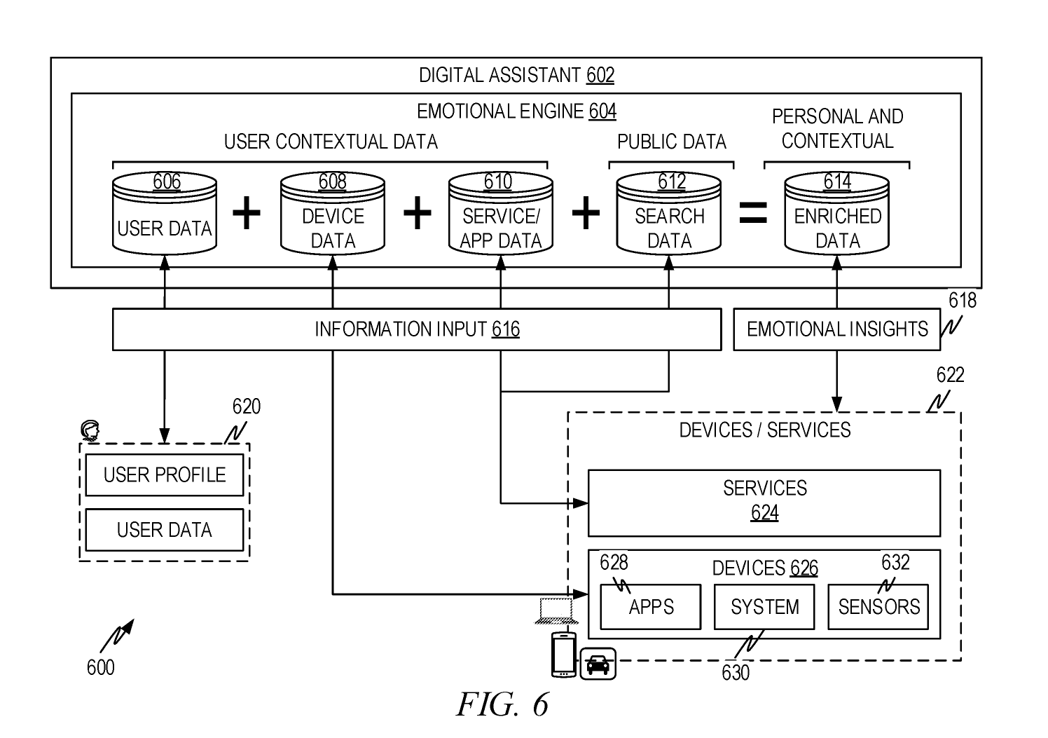

FIG. 4 illustrates an example architecture 400 to identify an emotional state from data and to customize operation of a system based on the extracted emotional state. The architecture comprises emotional engine 402, which can be part of an emotional system, such as the emotional system 106 of FIG. 1 or can be incorporated into other systems and/or services such as digital assistant 602 of FIG. 6.

Emotional engine 402 generates and/or accesses enriched data 404 to drive its processes. Enriched data 404 comprises data from a variety of sources such as data from a user 414 including user profile and/or user data (i.e., provided directly by a user), data gathered from services 418 and/or data gathered from devices 422 such as wearables, mobile devices, tablets, laptops, desktops, servers, internet of things (IOT) devices and so forth. The enriched data 404 can comprise both historical data and currently collected data to provide both historical insights as well as information about current happenings. This information can be provided based on current context or based on specific request by services/devices.

In some embodiments, at least a portion of the enriched data 404 (i.e., training data 406) can be used to train a machine learning model 408 to create an iteration of a personalized emotional state model for a user. In FIG. 4 this personalized emotional state model is illustrated as the emotional state graph 410. The emotional state graph can provide the emotional state vectors for reactive analysis by various emotional processes as well as provide indications of historical information (i.e., such as might be stored in enriched data 404) for proactive analysis by various services/devices as previously explained.

The emotional state graph 410 provides the information (i.e., emotional state vector, historical data, etc.) to allow emotional processes to extract emotional insights 412. The emotional insights 412 can include identified actions as previously discussed to change the operation of a services/device, change the emotional state vector, or both. Alternatively, or additionally, emotional insights can also comprise “trigger” information that would allow a service/device to identify one or more actions to take based on the trigger information. Trigger information may, for example, comprise the emotional state vector (e.g., emotional state and context data) to allow the service/device to identify not only what the current emotional state is, but the context that the emotional state is occurring in, and (in some embodiments) the reason that the “trigger” was identified (i.e., what caused the trigger information to be sent to the device/service).

The emotional insights can be sent to emotional modules 420, 430 associated with services 418 and/or devices 422 in order to allow the service 418 and/or device 422 to appropriately respond to the emotional insight. Responding to the emotional insight may include taking any of the actions previously described. Additionally, or alternatively, the emotional insights can be sent to other systems 432 from which information was not originally collected.

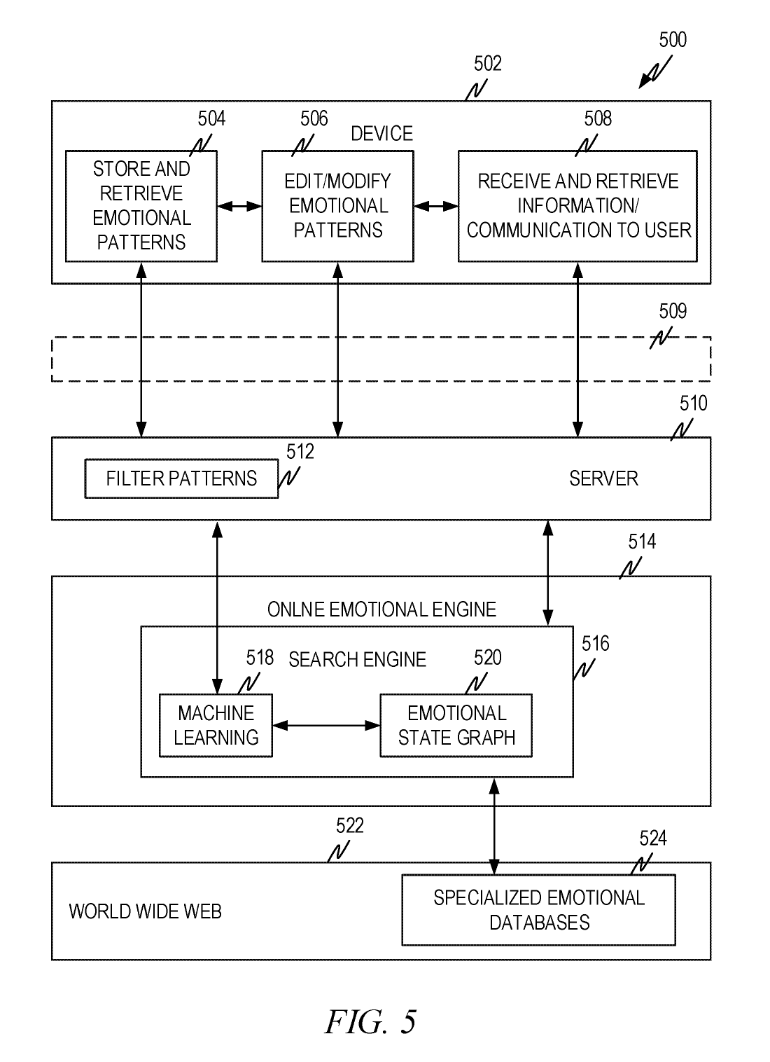

FIG. 5 illustrates another example architecture 500 to identify an emotional state from data and to customize operation of a system based on the extracted emotional state. This architecture comprises an online emotional engine 514 that can comprise, for example, a search engine 516 or other service. The search engine 516 comprises the machine learning model 518, that creates the personalized emotional state model, such as the illustrated emotional state graph 520.

As previously discussed, enriched data can be used to create the emotional state graph 520. In addition, there may be specialized emotional databases 524 available on the world wide web 522 or in other locations that can help create the emotional state graph 520. For example, many personality topologies have been developed that indicates common traits to different personality types. Myers-Briggs is a four-dimensional model with sixteen independent personality classes. The Big-Five or Five-Factor Model of Personality is another well-known model having a five-dimensional basis. Such personality typologies can provide clues as to how different typologies like to be communicated with (short fast, slower giving time to think, etc.) and traits that would allow the machine learning process to better estimate the emotional state from received data. Furthermore, the emotional state vector can incorporate dimensions associated with such personality typologies, to allow entities deciding what to do based on the emotional state vector to interpret what actions should be taken. For example, if received data indicates that the user is rather subdued and not very exuberant (i.e., based on monitoring communications, the pace of communications, the length of sentences used, etc.), if the person tends to be extroverted (as indicated by a personality typology), the system might interpret that as the user having a down or depressed emotional state, while of the person tends to be introverted (as indicated by a personality typology), the emotional state might indicate neither happiness nor sadness but rather the “normal” mode of communication for that individual.

A device 502 can request emotional patterns from the emotional state graph 520 to be sent to the device in order to provide local emotional capability. A request can be made through an intermediate server or service 510 which can filter the emotional patterns 512 and/or otherwise adapt the emotional patterns from the emotional state graph 520 to be compatible with the device 502. The emotional patterns can comprise, for example, the emotional insights of FIG. 4 and/or the emotional state vector(s) previously described. Additionally, or alternatively, the emotional patterns can allow the device 502 to implement a function identified by the server 510 and/or can be one or more of the emotional processes previously discussed that allows the device 502 to identify one or more actions to be taken based on the emotional insights and/or emotional state vectors.

The server 510 can execute a service and/or be a server that helps decide when and which emotional patterns (i.e., emotional insights, emotional state vectors and/or emotional processes) are passed along to the device. Thus, for example, the server 510 can be one of the other systems (108, 432) or can be the server that provides the interface between the online emotional engine 514 and the device 502. Additionally, or alternatively, other intermediate system(s) 509 can exist between the server 510 and the device 502.

The device 502 receives emotional patterns from the server 510, such as over a network. The emotional patterns are packaged in a message and transferred over the network via a suitable communications protocol. As an alternative to a message based interaction, remote procedure calls, calls to APIs and other mechanisms can be used to transfer the emotional patterns to the device.

The device 502 can provide several processes that utilize the emotional patterns, and other information received from the server 510 to adjust the operation of the device, implement an identified action, and so forth as described above. Process 504 stores and retrieves the emotional patterns. The process 504 communicates with the server 510 and receive the emotional patterns that are forwarded by the server 510 and store the emotional patterns in local storage. Additionally, or alternatively, the process 504 communicates with the server 510 to request desired emotional patterns and/or to send modified emotional patterns back to the server 510.

Process 506 facilitates editing and modification of emotional patterns. When emotional patterns comprise actions to be taken or comprise one or more emotional processes, the system may modify the emotional pattern based on feedback and data known to the device 502. For example, if an emotional pattern reconfigures the device to refuse communications except to a selected group of individuals when a given emotional state is detected, and the device 502 receives feedback that either the action needs to be modified or the emotional state associated with the action should be adjusted, the device 502 can modify the emotional pattern and the modified emotional pattern can be stored and/or sent to the server 510 (which would, in turn, forward the modified pattern to the online emotional engine) by the process 504. Additionally, or alternatively, the process 506 can allow the user to edit emotional patterns, whereupon process 504 can store the edited emotional pattern and/or forward the emotional pattern to the server 510.

Process 508 represents presentation of information and other communication with the user that happens as described herein. Thus process 508 can interact with the user interface, notification systems on the device, and other hardware and/or software to present information to the user and receive input from the user.

FIG. 6 illustrates another example architecture 600 to identify an emotional state from data and to customize operation of a system based on the extracted emotional state. The architecture 600 comprises a digital assistant 602 which can incorporate an emotional engine 604 such as one or more of the embodiments of the emotional engines described herein. Thus emotional engine 604 has been well described above.

As indicated, the emotional engine 604 receives date 616 from a variety of sources. Thus, the emotional engine 604 receives user data 606 from a user and/or user sources such as a user profile and/or user data 620. The emotional engine also receives device data 608 from devices 626. As previously discussed, the devices can be any type of device such as wearable, portable, semi-portable, no portable, IOT devices, vehicles, and so forth. The data may come from applications 628, system functionality 630, sensors 632 and/or other device sources. As previously discussed, this data includes, but is not limited to, location information, biometric (heart rate, skin temperature, respiration, etc.), movement history, application utilization, and/or a wide variety of other data. The emotional engine also receives service and/or application data 610 from services 624 that may provide data relevant to the user. Services and applications can analyze communications, such as text, email, voice, and other mechanisms to extract information about a user, the individual whom the user is communicating with, and/or the substance of the user's communications. Cameras can capture body language, eye contact, and so forth. Sensors can capture information about a user's environment (temperature, lighting, music playing, ambient noise level, and/or so forth), the force of typing on a keyboard, the smoothness and pressure of an ink trail, the pressure and duration of a tap on a touch input device, and/or so forth. Thus, the service/application data 610 can comprise any data from services or applications used by the user that are not accounted for by the devices. For example, in the conference call scenario above, the service/application data 610 can represent data collected by the conferencing service and/or digital assistant service. The user data 606, the device data 608 and the service/application data 610 comprises the contextual data utilized by the emotional engine to ascertain the emotional state vector.

In addition to contextual data, public data 612 exists that can help ascertain the emotional state vector. For example, data from social media, search history data, and other sources can yield information either on how to interpret the contextual data or additional data to help extract the emotional state vector.

The contextual data 606, 608, 610 and public data 612 is combined into an enriched data set 614, as previously discussed. From the enriched data set 614, emotional insights 618 are extracted and utilized by the devices/services 622 as previously discussed.

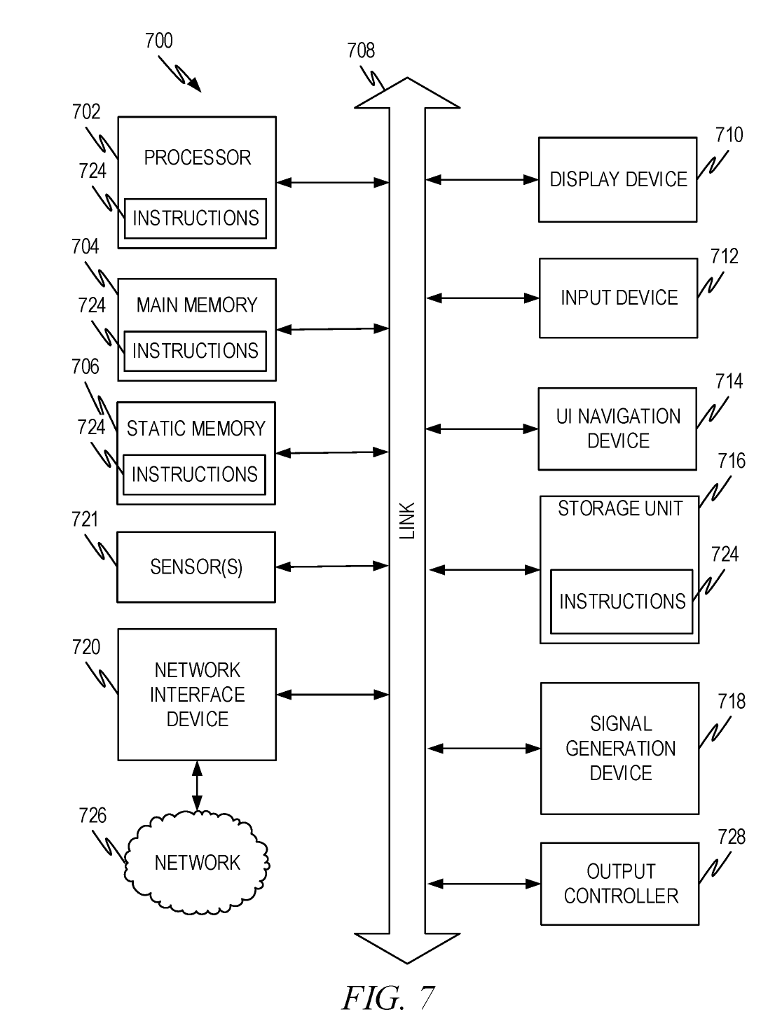

FIG. 7 illustrates a representative machine architecture suitable for implementing the systems and so forth or for executing the methods disclosed herein.

### Example Machine Architecture and Machine-Readable Medium

FIG. 7 illustrates a representative machine architecture suitable for implementing the systems and so forth or for executing the methods disclosed herein. The machine of FIG. 7 is shown as a standalone device, which is suitable for implementation of the concepts above. For the server aspects described above a plurality of such machines operating in a data center, part of a cloud architecture, and so forth can be used. In server aspects, not all of the illustrated functions and devices are utilized. For example, while a system, device, etc. that a user uses to interact with a server and/or the cloud architectures may have a screen, a touch screen input, etc., servers often do not have screens, touch screens, cameras and so forth and typically interact with users through connected systems that have appropriate input and output aspects. Therefore, the architecture below should be taken as encompassing multiple types of devices and machines and various aspects may or may not exist in any particular device or machine depending on its form factor and purpose (for example, servers rarely have cameras, while wearables rarely comprise magnetic disks). However, the example explanation of FIG. 7 is suitable to allow those of skill in the art to determine how to implement the embodiments previously described with an appropriate combination of hardware and software, with appropriate modification to the illustrated embodiment to the particular device, machine, etc. used.

While only a single machine is illustrated, the term “machine” shall also be taken to include any collection of machines that individually or jointly execute a set (or multiple sets) of instructions to perform any one or more of the methodologies discussed herein.

The example of the machine 700 includes at least one processor 702 (e.g., a central processing unit (CPU), a graphics processing unit (GPU), advanced processing unit (APU), or combinations thereof), one or more memories such as a main memory 704, a static memory 706, or other types of memory, which communicate with each other via link 708. Link 708 may be a bus or other type of connection channel. The machine 700 may include further optional aspects such as a graphics display unit 710 comprising any type of display. The machine 700 may also include other optional aspects such as an alphanumeric input device 712 (e.g., a keyboard, touch screen, and so forth), a user interface (UI) navigation device 714 (e.g., a mouse, trackball, touch device, and so forth), a storage unit 716 (e.g., disk drive or other storage device(s)), a signal generation device 718 (e.g., a speaker), sensor(s) 721 (e.g., global positioning sensor, accelerometer(s), microphone(s), camera(s), and so forth), output controller 728 (e.g., wired or wireless connection to connect and/or communicate with one or more other devices such as a universal serial bus (USB), near field communication (NFC), infrared (IR), serial/parallel bus, etc.), and a network interface device 720 (e.g., wired and/or wireless) to connect to and/or communicate over one or more networks 726.

### Executable Instructions and Machine-Readable Medium

The various memories (i.e., 704, 706, and/or memory of the processor(s) 702) and/or storage unit 716 may store one or more sets of instructions and data structures (e.g., software) 724 embodying or utilized by any one or more of the methodologies or functions described herein. These instructions, when executed by processor(s) 702 cause various operations to implement the disclosed embodiments.

As used herein, the terms “machine-readable medium,” “computer-readable medium” and “device-readable medium” mean the same thing and may be used interchangeably in this disclosure. The terms include a single medium or multiple media (e.g., a centralized or distributed database, and/or associated caches and servers) that store the one or more instructions or data structures. The terms shall also be taken to include any tangible medium that is capable of storing, encoding or carrying instructions for execution by the machine and that cause the machine to perform any one or more of the methodologies of the present invention, or that is capable of storing, encoding or carrying data structures utilized by or associated with such instructions. The terms shall accordingly be taken to include, but not be limited to, solid-state memories, and optical and magnetic media. Specific examples of machine-readable media, computer-readable media and/or device-readable media include non-volatile memory, including by way of example semiconductor memory devices, e.g., erasable programmable read-only memory (EPROM), electrically erasable programmable read-only memory (EEPROM), and flash memory devices; magnetic disks such as internal hard disks and removable disks; magneto-optical disks; and CD-ROM and DVD-ROM disks. The terms machine-readable media, computer-readable media, and device-readable media specifically exclude non-statutory signals per se, which are covered under the term “signal medium” discussed below.

### Signal Medium

The term “signal medium” shall be taken to include any form of modulated data signal and signals per se. The term “modulated data signal” means a signal that has one or more of its characteristics set or changed in such a matter as to encode information in the signal.

### EXAMPLE EMBODIMENTS

### Example 1

A method for personalizing user interaction with a machine, comprising:

receiving data comprising user contextual data (606, 608, 610) and user public data (612), the data being received from a plurality of data sources (102, 414, 416, 620, 622);

combining the received data to create an enriched data set (404, 614) for a user comprising personal data and contextual data;

extracting an emotional state (412, 618) from the enriched data set by presenting the enriched data to an emotional state model personalized to the user (408), the emotional state model created through application of a machine learning algorithm to collected data regarding the user;

identifying at least one action based on the extracted emotional state, the at least one action designed to perform at least one of modifying the operation of a machine and modifying the emotional state;

identifying at least one device and at least one channel to achieve the at least one action through engaging one or more senses of the user (308);

formatting data to be transmitted over the at least one channel to at least one device to initiate the at least one action (310);

receiving data indicative of explicit or implicit feedback regarding how the at least one action was received by the user (312);

updating the emotional state and the emotional state model based on the data indicative of feedback (314).

### Example 2

The method of example 1, further comprising:

identifying at least one additional action based on at least one of the updated emotional state and the updated emotional state model;

identifying at least one device and at least one channel to achieve the at least one additional action through engaging one or more senses of the user;

formatting data to be transmitted over the at least one channel to at least one device to initiate the at least one additional action;

receiving data indicative of explicit or implicit feedback regarding how the at least one additional action was received by the user;

updating the emotional state and the emotional state model based on the feedback regarding the at least one additional action.

### Example 3

The method of example 1 wherein combining the received data to create an enriched data set for a user comprising personal data and contextual data comprises at least one of:

time aligning data points of the data from the plurality of data sources;

reducing the number of data points from one or more of the plurality of data sources;

aggregating the data points of the data from the plurality of data sources;

normalizing the data points from one or more of the plurality of data sources; and

changing format of the data points from one or more of the plurality of data sources.

### Example 4

The method of example 1, further comprising:

receiving data from a second plurality of data sources comprising second user contextual data and second user public data;

combining the received data to create an enriched data set for a second user comprising personal data and contextual data for the second user;

extracting a second emotional state from the enriched data set by presenting the enriched data to an emotional state model personalized to the second user;

identifying the at least one action based the second emotional state in addition to the emotional state;

receiving second data indicative of explicit or implicit feedback on how the at least one action was received by the second user; and

updating the second emotional state based on the second data indicative of feedback.

### Example 5

The method of example 1, 2, 3, or 4, wherein the user contextual data is received from at least one first device and wherein the at least one action is achieved through at least one second device different from the at least one first device.

### Example 6

The method of example 5, wherein the at least one second device comprises a chatbot or digital assistant.

### Example 7

The method of example 1, 2, 3, or 4, wherein the at least one action comprises at least one of:

vibrating a wearable device;

changing a temperature of an environment where the user is located;

changing lighting of the environment where the user is located;

changing a mode of interaction with the user;

changing a frequency of interaction with the user;

changing the length of sentences used to communicate with the user;

changing music that is playing;

changing vocal tone; and

changing word choice.

### Example 8

The method of example 1, 2, 3, or 4, wherein identifying the at least one action comprises:

identifying a desired emotional state different from the emotional state; and

identifying an action calculated to produce the desired emotional state based on correlations between past data and the desired emotional state.

### Example 9

A computing system comprising:

a processor and executable instructions accessible on a machine-readable medium that, when executed, cause the system to perform operations comprising:

receive data comprising user contextual data (606, 608, 610) and user public data (612), the data being received from a plurality of data sources (102, 414, 416, 620, 622);

combine the received data to create an enriched data (404, 614) set for a user comprising personal data and contextual data;

extract an emotional state (412, 618) from the enriched data set by presenting the enriched data to an emotional state model personalized to the user, the emotional state model created through application of a machine learning algorithm to collected data regarding the user;

identify at least one action based on the extracted emotional state, the at least one action operable to modify the operation of a device to change interactions with the user (308);

identify at least one channel to the device (310);

formatting data to be transmitted over the at least one channel to the device to initiate the at least one action (310);

receiving data indicative of explicit or implicit feedback regarding how the at least one action was received by the user (312);

updating the emotional state based on the data indicative of feedback (314).

### Example 10

The system of example 9, further comprising:

identifying at least one additional action based on at least one of the updated emotional state and the updated emotional state model;

identifying at least one device and at least one channel to achieve the at least one additional action through engaging one or more senses of the user;

formatting data to be transmitted over the at least one channel to at least one device to initiate the at least one additional action;

receiving data indicative of explicit or implicit feedback regarding how the at least one additional action was received by the user;

updating the emotional state and the emotional state model based on the feedback regarding the at least one additional action.

### Example 11

The system of example 9 wherein combining the received data to create an enriched data set for a user comprising personal data and contextual data comprises at least one of:

time aligning data points of the data from the plurality of data sources;

reducing the number of data points from one or more of the plurality of data sources;

aggregating the data points of the data from the plurality of data sources;

normalizing the data points from one or more of the plurality of data sources; and

changing format of the data points from one or more of the plurality of data sources.

### Example 12

The system of example 9, further comprising:

receiving data from a second plurality of data sources comprising second user contextual data and second user public data;

combining the received data to create an enriched data set for a second user comprising personal data and contextual data for the second user;

extracting a second emotional state from the enriched data set by presenting the enriched data to an emotional state model personalized to the second user;

identifying the at least one action based the second emotional state in addition to the emotional state;

receiving second data indicative of explicit or implicit feedback on how the at least one action was received by the second user; and

updating the second emotional state based on the second data indicative of feedback.

### Example 13

The system of example 9, 10, 11, or 12, wherein the user contextual data is received from at least one first device and wherein the at least one action is achieved through at least one second device different from the at least one first device.

### Example 14

The system of example 13, wherein the at least one first device comprises a mobile device and the second device comprises a service.

### Example 15

The system of example 9, 10, 11, or 12, wherein the at least one action comprises at least one of:

changing a mode of interaction with the user;

changing a frequency of interaction with the user; and

changing the length of sentences used to communicate with the user.

### Example 16

The system of example 9, 10, 11, or 12, wherein the at least one action is calculated to make interactions with the user compatible with the emotional state.

### Example 17

A machine-readable medium having executable instructions encoded thereon, which, when executed by at least one processor of a machine, cause the machine to perform operations comprising:

receive data comprising user contextual data (606, 608, 610) and user public data (612), the data being received from a plurality of data sources (102, 414, 416, 620, 622);

combine the received data to create an enriched data set (404, 614) for a user comprising personal data and contextual data;

extract an emotional state (412, 618) from the enriched data set by presenting the enriched data to an emotional state model personalized to the user (408), the emotional state model created through application of a machine learning algorithm to collected data regarding the user;

identify at least one action to be implemented by at least one device or service based on the extracted emotional state;

identify at least one channel to the at least one device (310);

formatting data to be transmitted over the at least one channel to the at least one device or service (310);

receiving data indicative of explicit or implicit feedback regarding how the at least one action was received by the user (312);

updating the emotional state based on the data indicative of feedback (314).

### Example 18

The machine-readable medium of example 17, wherein the at least one action comprises a proactive emotional insight.

### Example 19

The machine-readable medium of example 17, wherein the at least one action comprises a reactive emotional insight.

### Example 20

The machine-readable medium of example 17, 18, or 19, wherein the at least one action is based on a plurality of emotional states, each associated a different user, and wherein the at least one action is directed to a plurality of users.

### Example 21

A method for personalizing user interaction with a machine, comprising:

receiving data comprising user contextual data (606, 608, 610) and user public data (612), the data being received from a plurality of data sources (102, 414, 416, 620, 622);

combining the received data to create an enriched data set (404, 614) for a user comprising personal data and contextual data;

extracting an emotional state (412, 618) from the enriched data set by presenting the enriched data to an emotional state model personalized to the user (408), the emotional state model created through application of a machine learning algorithm to collected data regarding the user;

identifying at least one action based on the extracted emotional state, the at least one action designed to perform at least one of modifying the operation of a machine and modifying the emotional state;

identifying at least one device and at least one channel to achieve the at least one action through engaging one or more senses of the user (308);

formatting data to be transmitted over the at least one channel to at least one device to initiate the at least one action (310);

receiving data indicative of explicit or implicit feedback regarding how the at least one action was received by the user (312);

updating the emotional state and the emotional state model based on the data indicative of feedback (314).

### Example 22

The method of claim 21, further comprising:

identifying at least one additional action based on at least one of the updated emotional state and the updated emotional state model;

identifying at least one device and at least one channel to achieve the at least one additional action through engaging one or more senses of the user;

formatting data to be transmitted over the at least one channel to at least one device to initiate the at least one additional action;

receiving data indicative of explicit or implicit feedback regarding how the at least one additional action was received by the user;

updating the emotional state and the emotional state model based on the feedback regarding the at least one additional action.

### Example 23

The method of claim 21 or 22 wherein combining the received data to create an enriched data set for a user comprising personal data and contextual data comprises at least one of:

time aligning data points of the data from the plurality of data sources;

reducing the number of data points from one or more of the plurality of data sources;

aggregating the data points of the data from the plurality of data sources;

normalizing the data points from one or more of the plurality of data sources; and

changing format of the data points from one or more of the plurality of data sources.

### Example 24

The method of claim 21, 22, or 23 further comprising:

receiving data from a second plurality of data sources comprising second user contextual data and second user public data;

combining the received data to create an enriched data set for a second user comprising personal data and contextual data for the second user;

extracting a second emotional state from the enriched data set by presenting the enriched data to an emotional state model personalized to the second user;

identifying the at least one action based the second emotional state in addition to the emotional state;

receiving second data indicative of explicit or implicit feedback on how the at least one action was received by the second user; and

updating the second emotional state based on the second data indicative of feedback.

### Example 25

The method of claim 21, 22, 23, or 24, wherein the user contextual data is received from at least one first device and wherein the at least one action is achieved through at least one second device different from the at least one first device.

### Example 26

The method of claim 25, wherein the at least one second device comprises a chatbot or digital assistant.

### Example 27

The method of claim 26, wherein the at least one first device comprises a mobile device and the second device comprises a service.

### Example 28

The method of claim 21, 22, 23, 24, 25, 26, or 27, wherein the at least one action comprises at least one of:

vibrating a wearable device;

changing a temperature of an environment where the user is located;

changing lighting of the environment where the user is located;

changing a mode of interaction with the user;

changing a frequency of interaction with the user;

changing the length of sentences used to communicate with the user;

changing music that is playing;

changing vocal tone; and

changing word choice.

### Example 29

The method of claim 21, 22, 23, 24, 25, 26, 27, or 28, wherein identifying the at least one action comprises:

identifying a desired emotional state different from the emotional state; and

identifying an action calculated to produce the desired emotional state based on correlations between past data and the desired emotional state.

### Example 30

The method of claim 21, 22, 23, 24, 25, 26, 27, 28, or 29, wherein the at least one action comprises at least one of:

changing a mode of interaction with the user;

changing a frequency of interaction with the user;

changing the word choice to communicate with the user; and

changing the length of sentences used to communicate with the user.

### Example 31

The method of claim 21, 22, 23, 24, 25, 26, 27, 28, 29, or 30, wherein the at least one action is calculated to make interactions with the user compatible with the emotional state.

### Example 32

The method of claim 21, 22, 23, 24, 25, 26, 27, 28, 29, 30, or 31, wherein the at least one action comprises a proactive emotional insight or a reactive emotional insight.

### Example 33

The method of claim 21, 22, 23, 24, 25, 26, 27, 28, 29, 30, 31, or 32, wherein the at least one action is based on a plurality of emotional states, each associated a different user, and wherein the at least one action is directed to a plurality of users.

### Example 34

An apparatus comprising means to perform a method as in any preceding example.

### Example 35

Machine-readable storage including machine-readable instructions, when executed, to implement a method or realize an apparatus as in any preceding example.

### CONCLUSION

In view of the many possible embodiments to which the principles of the present invention and the forgoing examples may be applied, it should be recognized that the examples described herein are meant to be illustrative only and should not be taken as limiting the scope of the present invention. Therefore, the invention as described herein contemplates all such embodiments as may come within the scope of the following claims and any equivalents thereto.

What is claimed is:

1. A method for personalizing user interaction with a machine, comprising:
receiving data comprising user contextual data and user public data, the data being received from a plurality of data sources;
combining the received data to create an enriched data set for a user comprising personal data and contextual data;
extracting an emotional state from the enriched data set by presenting the enriched data to an emotional state model personalized to the user, the emotional state model created through application of a machine learning algorithm to collected data regarding the user;
identifying at least one action based on the extracted emotional state, the at least one action designed to perform at least one of modifying the operation of a machine and modifying the emotional state;
identifying at least one device and at least one channel to achieve the at least one action through engaging one or more senses of the user;
formatting data to be transmitted over the at least one channel to at least one device to initiate the at least one action;
receiving data indicative of explicit or implicit feedback regarding how the at least one action was received by the user;
updating the emotional state and the emotional state model based on the data indicative of feedback.

2. The method of claim 1, further comprising:
identifying at least one additional action based on at least one of the updated emotional state and the updated emotional state model;
identifying at least one device and at least one channel to achieve the at least one additional action through engaging one or more senses of the user;
formatting data to be transmitted over the at least one channel to at least one device to initiate the at least one additional action;
receiving data indicative of explicit or implicit feedback regarding how the at least one additional action was received by the user;
updating the emotional state and the emotional state model based on the feedback regarding the at least one additional action.

3. The method of claim 1 wherein combining the received data to create an enriched data set for a user comprising personal data and contextual data comprises at least one of:
time aligning data points of the data from the plurality of data sources;
reducing the number of data points from one or more of the plurality of data sources;
aggregating the data points of the data from the plurality of data sources;
normalizing the data points from one or more of the plurality of data sources; and
changing format of the data points from one or more of the plurality of data sources.

4. The method of claim 1, further comprising:
receiving data from a second plurality of data sources comprising second user contextual data and second user public data;
combining the received data to create an enriched data set for a second user comprising personal data and contextual data for the second user;
extracting a second emotional state from the enriched data set by presenting the enriched data to an emotional state model personalized to the second user;
identifying the at least one action based the second emotional state in addition to the emotional state;
receiving second data indicative of explicit or implicit feedback on how the at least one action was received by the second user; and
updating the second emotional state based on the second data indicative of feedback.

5. The method of claim 1, wherein the user contextual data is received from at least one first device and wherein the at least one action is achieved through at least one second device different from the at least one first device.

6. The method of claim 5, wherein the at least one second device comprises a chatbot or digital assistant.

7. The method of claim 1, wherein the at least one action comprises at least one of:
vibrating a wearable device;
changing a temperature of an environment where the user is located;
changing lighting of the environment where the user is located;
changing a mode of interaction with the user;
changing a frequency of interaction with the user;
changing the length of sentences used to communicate with the user;
changing music that is playing;
changing vocal tone; and
changing word choice.

8. The method of claim 1, wherein identifying the at least one action comprises:
identifying a desired emotional state different from the emotional state; and
identifying an action calculated to produce the desired emotional state based on correlations between past data and the desired emotional state.

9. A computing system comprising:
a processor and executable instructions accessible on a machine-readable medium that, when executed, cause the system to perform operations comprising:
receive data comprising user contextual data and user public data, the data being received from a plurality of data sources;
combine the received data to create an enriched data set for a user comprising personal data and contextual data;
extract an emotional state from the enriched data set by presenting the enriched data to an emotional state model personalized to the user, the emotional state model created through application of a machine learning algorithm to collected data regarding the user;
identify at least one action based on the extracted emotional state, the at least one action operable to modify the operation of a device to change interactions with the user;
identify at least one channel to the device;
formatting data to be transmitted over the at least one channel to the device to initiate the at least one action;
receiving data indicative of explicit or implicit feedback regarding how the at least one action was received by the user;
updating the emotional state based on the data indicative of feedback.

10. The system of claim 9, further comprising:
identifying at least one additional action based on at least one of the updated emotional state and the updated emotional state model;
identifying at least one device and at least one channel to achieve the at least one additional action through engaging one or more senses of the user;
formatting data to be transmitted over the at least one channel to at least one device to initiate the at least one additional action;
receiving data indicative of explicit or implicit feedback regarding how the at least one additional action was received by the user;
updating the emotional state and the emotional state model based on the feedback regarding the at least one additional action.

11. The system of claim 9 wherein combining the received data to create an enriched data set for a user comprising personal data and contextual data comprises at least one of:
time aligning data points of the data from the plurality of data sources;
reducing the number of data points from one or more of the plurality of data sources;
aggregating the data points of the data from the plurality of data sources;
normalizing the data points from one or more of the plurality of data sources; and
changing format of the data points from one or more of the plurality of data sources.

12. The system of claim 9, further comprising:
receiving data from a second plurality of data sources comprising second user contextual data and second user public data;
combining the received data to create an enriched data set for a second user comprising personal data and contextual data for the second user;
extracting a second emotional state from the enriched data set by presenting the enriched data to an emotional state model personalized to the second user;
identifying the at least one action based the second emotional state in addition to the emotional state;
receiving second data indicative of explicit or implicit feedback on how the at least one action was received by the second user; and
updating the second emotional state based on the second data indicative of feedback.

13. The system of claim 9, wherein the user contextual data is received from at least one first device and wherein the at least one action is achieved through at least one second device different from the at least one first device.

14. The system of claim 13, wherein the at least one first device comprises a mobile device and the second device comprises a service.

15. The system of claim 9, wherein the at least one action comprises at least one of:
changing a mode of interaction with the user;
changing a frequency of interaction with the user; and
changing the length of sentences used to communicate with the user.

16. The system of claim 9, wherein the at least one action is calculated to make interactions with the user compatible with the emotional state.

17. A machine-readable medium having executable instructions encoded thereon, which, when executed by at least one processor of a machine, cause the machine to perform operations comprising:
receive data comprising user contextual data and user public data, the data being received from a plurality of data sources;
combine the received data to create an enriched data set for a user comprising personal data and contextual data;
extract an emotional state from the enriched data set by presenting the enriched data to an emotional state model personalized to the user, the emotional state model created through application of a machine learning algorithm to collected data regarding the user;
identify at least one action to be implemented by at least one device or service based on the extracted emotional state;
identify at least one channel to the at least one device;
formatting data to be transmitted over the at least one channel to the at least one device or service;
receiving data indicative of explicit or implicit feedback regarding how the at least one action was received by the user;
updating the emotional state based on the data indicative of feedback.

18. The machine-readable medium of claim 17, wherein the at least one action comprises a proactive emotional insight.

19. The machine-readable medium of claim 17, wherein the at least one action comprises a reactive emotional insight.

20. The machine-readable medium of claim 17, wherein the at least one action is based on a plurality of emotional states, each associated a different user, and wherein the at least one action is directed to a plurality of users.
